(19) United States
(12) Patent Application Publication
(10) Pub. No.: US 2007/0145725 A1
(43) Pub. Date: Jun. 28, 2007

(54) Neck-protecting device on a seat in an automobile

(76) Inventor: Tsai-Sun Chen, Taipei (TW)

Correspondence Address: TROXELL LAW OFFICE PLLC;SUITE 1404, 5205 LEESBRUG PIKE, FALLS CHURCH, VA, 22041, US

(21) Appl. No.: 11/487,491

(22) Filed: Jul. 17, 2006

(30) Foreign Application Priority Data
Dec. 28, 2005 (TW) 094220126

(51) Int. Cl. B60R 21/207

(52) U.S. Cl. 280/730.1

(57) ABSTRACT

A neck-protecting device includes an expansible gasbag attached to a headrest on a seat of an automobile, a container for storing pressurized gas, a normally closed valve having one port in fluid communication with the expansible gasbag and the other port in fluid communication with the container, and a valve-opening means for opening the normally closed valve in response to a collision.

### FIELD OF THE INVENTION

The present invention relates to a neck-protecting device on a seat in an automobile and, more particularly, to such a device that drives gas from a container to inflate an expansible gasbag after a collision, and is suitable for being deposited at a headrest of a seat in various vehicles.

### BACKGROUND OF THE INVENTION

The system of air bag is well-known in the automobile industry. It is a safety device that has a bag designed to inflate upon collision to protect an occupant sitting on the front seat from colliding with the steering wheal or the windshield. Today, cars produced in American are necessary to be equipped with air bags for the statistics show that during the ten years from 1986 to 1995 air bags saved more than 1,136 persons' lives and, in head-on collision, reduced the mortality among occupants up to 30 percents. The system of air bag generally includes an electronic sensor arranged in the head of an automobile, a microprocessor, an expansible bag, and chemical substances held in the expansible for generating gas.

As the automobile is traveling, the electronic sensor always detects the speed and the vibration of the vehicle and sends a signal to a microprocessor that compares the signal with a standard one. If it is affirmed that a collision happens, the microprocessor will send out a current impulse to light the chemical substance NaN₃ in the expansible bag within which a series of chemical reactions are brought about and a large amount of nitrogen N₂ is released. The bag will be filled with the gas within about 20 to 30 milliseconds.

The air bag can protect the front part of the human body, including the chest and the belly, in a collision, but can not protect the rear part of the same due to the fact that the human body is often moved backward immediately after forward as a result either of the inertia or the rebounding from the air bag, and then the back of the head and the human body collide with a headrest and a seatback respectively.

Although the back of the head and the human body will not be hurt badly, the part between them, the neck, may be overstretched and sprained.

### SUMMARY OF THE INVENTION

One objective of the present invention is to provide a device for protecting the neck of an occupant in an automobile upon collision.

Another objective of the present invention is to provide such a device that has a simplified structure and can be made cheaply.

To achieve the aforementioned objects, the present invention provides a device including an expansible gasbag attached to a headrest on a seat of an automobile, a container for storing pressurized gas, a normally closed valve having one port in fluid communication with the expansible gasbag and the other port in fluid communication with the container, and a valve-opening means for opening the normally closed valve in response to a collision.

Other objectives, advantages and novel features of this invention will become more apparent from the following detailed description when taken in conjunction with the accompanying drawings.

### BRIEF DESCRIPTION OF THE DRAWINGS

FIG. 1 is an exploded perspective view of a preferred embodiment of a device in accordance with the present invention;

FIG. 2 is a perspective view showing the device of FIG. 1 in assembly;

FIG. 3 is a schematic view showing a valve of the device in a closed position before a collision;

FIG. 4 is a schematic view showing the valve of the device in an open position in a collision; and

FIG. 5 is a schematic view showing an expansible gasbag of the device attached to a headrest on a seat of an automobile in use.

### DETAILED DESCRIPTION OF THE PREFERRED EMBODIMENT

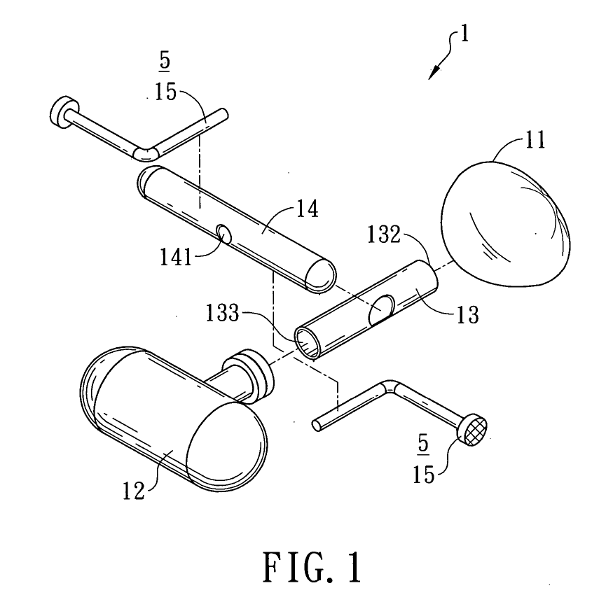

Referring to FIG. 1˜3, there is shown a preferred embodiment of a neck-protecting device 1 according to the present invention. The device 1 includes an expansible gasbag 11, a container 12 for storing pressurized gas 121, a normally closed valve (not numbered) for controlling the flow of the pressurized gas 121, especially noncombustible one, from the container 12 to the expansible gasbag 11, and a valve-opening means 5 for opening the normally closed valve in response to a collision.

In the illustrated embodiment, the normally closed valve includes a tubular member 13 having an inner passage ending in one port 132 in fluid communication with the expansible gasbag 11 and the other port 133 in fluid communication with the container 12, and a lateral shaft 14 extending across the tubular member 13.

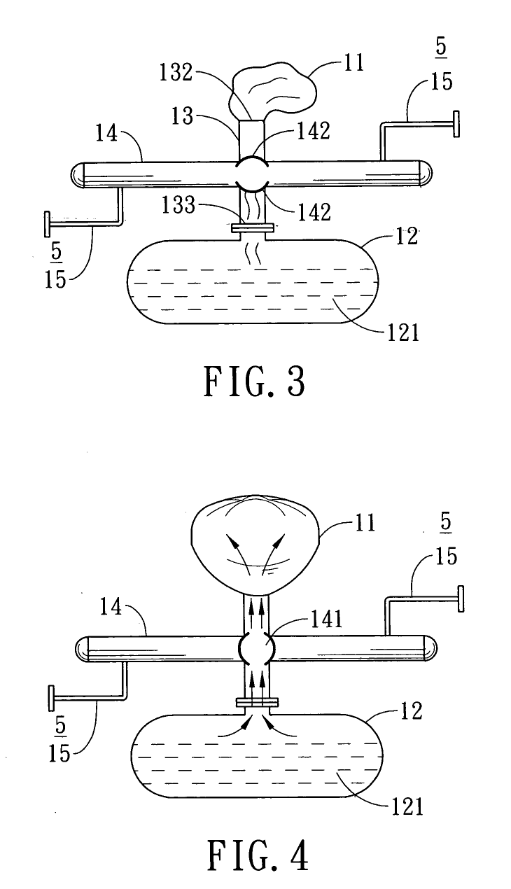

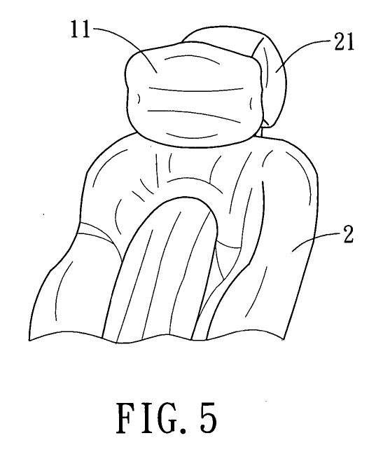

The shaft 14 has a through-hole 141 defined in a location at the inner passage between the ports 132 and 133. The shaft 14 is capable of being turned around its longitudinal axis, relative to the tubular member 13, between the first angular position in which the through-hole 141 is misaligned with the inner passage of the tubular member 13 to such an extend that the inner passage is obstructed by the periphery 142 of the shaft 14 and so the valve is closed, as shown in FIG. 3, and the second angular position in which the through-hole 141 is substantially aligned with the inner passage of the tubular member 13 to such an extend that the inner passage of the tubular member 13 is unobstructed and so the normally closed valve is opened, as shown in FIG. 4. It is important that the shaft 14 is normally in its first angular position, thereby making the valve to be normally closed.

The valve-opening means 5 for opening the normally closed valve include plural cranks 15 attached to the lateral shaft 14 in such a way that the plural cranks 15 may turn the lateral shaft 14 from the first angular position to the second angular position under the action of their inertial force resulted from a collision.

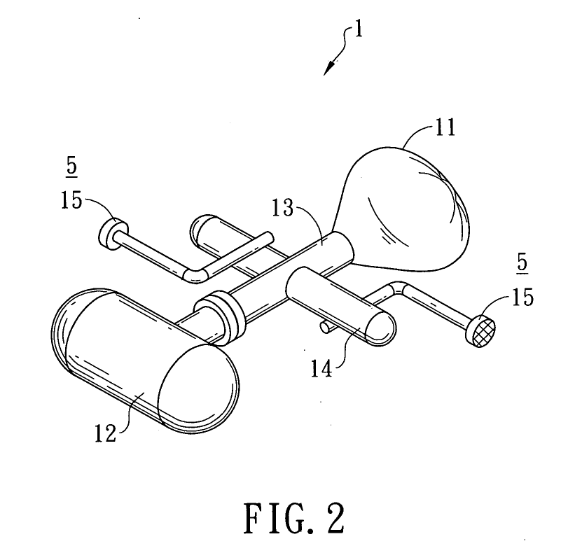

Referring to FIG. 1 and 2, the device 1 can be assembled by extending the lateral shaft 14 across the tubular member 13 and remaining the same lateral shaft 14 in the first angular position. The expansible gasbag 11 and the container 12 are then connected to the ports 132 and 133 of the tubular member 13 before the cranks 15 are attached to the lateral shaft 14.

Because the shaft 14 is now in its first angular position, the inner passage of the tubular member 13 is obstructed by the periphery 142 of the shaft 14, i.e., the normally closed valve remains closed, and so the pressurized gas 121 in the container 12 can't flow into the expansible gasbag 11 through the tubular member 13, as shown in FIG. 3. Attaching the expansible gasbag 11 to a headrest 21 on a seat 2 of an automobile, as clearly shown in FIG. 5, finishes the assembly.

If an accidental collision happens to the automobile, the plural cranks 15 are acted by inertial force and will turn the shaft 14 to the second angular position, in which the inner passage of the tubular member 13 is unobstructed, i.e., the normally closed valve is opened. As a result, the pressurized gas 121 in the container 12 will flow into the expansible gasbag 11 through the tubular member 13 and the expansible gasbag 11 will be inflated, as shown in FIG. 4.

From the foregoing, it is apparent that the present invention is advantageous in that:
1. The expansible gasbag will be inflated instantly in a collision to catch the backwardly moved neck of an occupant in an automobile, thus protecting the neck from being overstretched and sprained.
2. The device works on a simple principle without using any electronic switches or sensors and can be made cheaply due to its simplified structure.

Although the embodiment together with its structure and functions of the present invention has been described in detail, many modifications and variations may be made from the teachings disclosed herein. Therefore, it should be understood by those skilled in the art that any modification or variation equivalent to the spirit of the present invention is regarded to fall into the scope defined by the appended claims.

What is claimed is:

1. A neck-protecting device on a seat in an automobile comprising:
an expansible gasbag attached to a headrest on a seat of said automobile;
a container for storing pressurized gas;
a normally closed valve having one port in fluid communication with said inflatable gasbag and the other port in fluid communication with said container; and
a valve-opening means for opening said normally closed valve in response to a collision of said automobile.

2. The device as claimed in claim 1, wherein said normally closed valve comprises:
a tubular member having an inner passage ending in said ports;
a lateral shaft extending across said tubular member and having a through-hole defined in a location at said inner passage between said ports; and
said lateral shaft being capable of being turned relative to said tubular member between the first angular position in which said through-hole is misaligned with said inner passage of said tubular member to such an extend that said normally closed valve is closed, and the second angular position in which said through-hole is substantially aligned with said inner passage of said tubular member to such an extend that said normally closed valve is opened;
wherein said lateral shaft is normally in said first angular position, thereby making said valve to be normally closed.

3. The device as claimed in claim 2, wherein said valve-opening means for opening have at least one crank attached to said lateral shaft in such a way that said at least one crank may turn said lateral shaft from said first angular position to said second angular position under the action of the inertial force resulted from said collision.

4. The device as claimed in claim 2, wherein said pressurized gas is noncombustible.
